(19) United States
(12) Patent Application Publication
(10) Pub. No.: US 2017/0038879 A1
(43) Pub. Date: Feb. 9, 2017

(54) DISPLAY PANEL WITH AN IN-CELL FORCE SENSOR

(71) Applicant: FocalTech Systems Co., Ltd., Hsinchu (TW)

(72) Inventor: Pei-Hung HSIAO, Hsinchu (TW)

(21) Appl. No.: 15/079,104

(22) Filed: Mar. 24, 2016

(30) Foreign Application Priority Data
Aug. 4, 2015 (TW) 104125281

(51) Int. Cl. G06F 3/041

(52) U.S. Cl. CPC G06F 3/0414; G06F 3/0412; G06F 3/0416; G06F 2203/04103; G06F 2203/04105

(57) ABSTRACT

A display panel with an in-cell force sensor includes an array glass and a transparent protective layer disposed on the array glass, which has first to fourth sides. An integrated circuit is disposed on the display panel and close to the first side, and provided with an operational amplifier. The array glass is divided into an active area provided with a thin film transistor array and a non-active area provided with a plurality of metal lines connected to the integrated circuit, and the transparent protective layer covers the plurality of metal lines, whereby the plurality of metal lines and the operational amplifier of the integrated circuit constitute a strain gauge.

### BACKGROUND OF THE INVENTION

1. Field of the Invention

The present invention relates to the technical field of touch panels and, more particularly, to a display panel with an in-cell force sensor.

2. Description of Related Art

With the rapid development of the flat display industry, many products are continuously created in pursuit of light weight, slimness, small volume, and high image quality. Thus, various flat displays have been developed to replace cathode ray tubes (CRTs). In addition to the features of light weight, slimness and small volume, a touch function is newly added to the flat displays. The flat touch display device is constructed by directly overlying a touch panel on a flat display. Since the touch panel is a transparent panel, image produced from the flat display can pass through the upper touch panel to display, while the touch panel is used as an input medium or interface.

In addition, with the rapid development of the electronic technology, the application of sensors becomes very close to human living. For example, the sensors are largely used from the home appliances, such as electric rice cookers, washing machines, refrigerators, and the like, to motorcycles, cars, airplanes, automated equipment, and satellites. The new generation of touch control technology can use 3D force sensors to sense different touch forces at the same touch point on the touch panel so as to distinguish the point of light touch from the point of heavy touch for immediately performing a series of corresponding operations. For example, when a heavy touch is applied to the screen, control items of the app program, such as “message”, “music” and “calendar”, can be displayed. However, such a 3D force touch sensing requires the installation of the force sensors in practice, and thus the cost of the touch sensing is greatly increased.

Therefore, it is desirable to provide an improved display panel with an in-cell force sensor to mitigate and/or obviate the aforementioned problems.

### SUMMARY OF THE INVENTION

The object of the present invention is to provide a display panel with an in-cell force sensor, in which a plurality of metal lines and an integrated circuit are used to form a full-bridge load cell so as to provide the display panel with a force sensing function.

To achieve the object, there is provided a display panel with an in-cell force sensor comprising an array glass and a transparent protective layer disposed on the array glass, which has a first side, a second side, a third side opposite to the first side, and a fourth side opposite to the second side. An integrated circuit is disposed on the display panel and close to the first side, and provided with an operational amplifier. The array glass is divided into an active area provided with a thin film transistor array and a non-active area provided with a plurality of metal lines connected to the integrated circuit, and the transparent protective layer covers the plurality of metal lines, whereby the plurality of metal lines and the operational amplifier of the integrated circuit constitute a strain gauge.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a display panel with an in-cell force sensor according to an embodiment of the invention;

FIG. 2 is a schematic diagram of a display panel with an in-cell force sensor according to another embodiment of the invention;

FIG. 3 is a schematic diagram illustrating an operation of a display panel with an in-cell force sensor according to the invention; and

FIGS. 4A and 4B are schematic diagrams illustrating an application of a display panel with an in-cell force sensor according to the invention.

### DETAILED DESCRIPTION OF THE PREFERRED EMBODIMENT

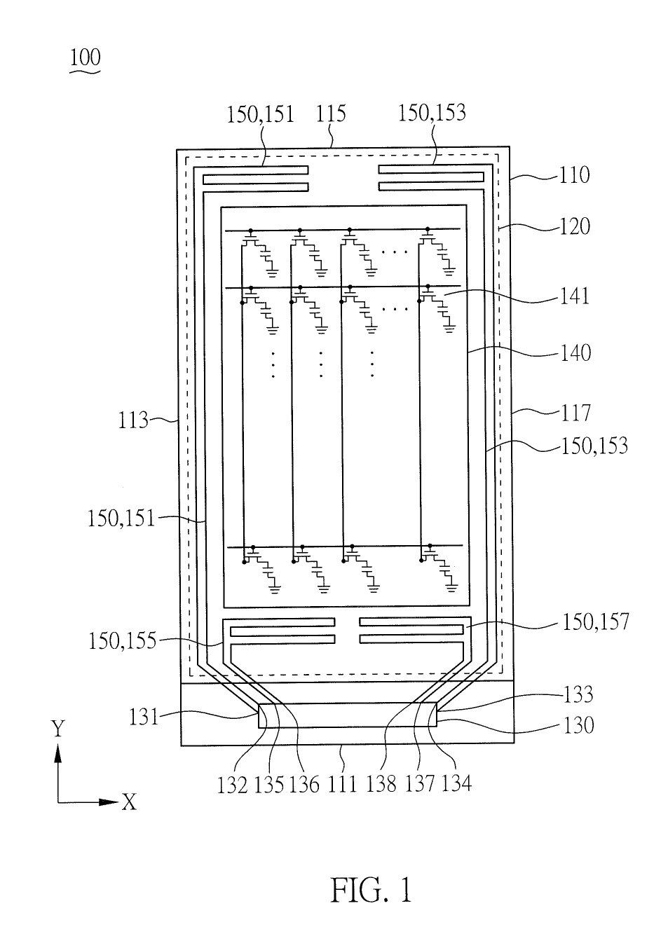

FIG. 1 is a schematic diagram of a display panel 100 with an in-cell force sensor according to an embodiment of the invention. The display panel 100 includes an array glass 110 and a transparent protective layer 120 disposed on the array glass 110, and further includes a first side 111, a second side 113, a third side 115 opposite to the first side 111, and a fourth side 117 opposite to the second side 113. The size of the transparent protective layer 120 is about equal to that of the array glass 110. However, for clearly showing the array glass 110, the transparent protective layer 120 is illustrated to be slightly smaller than the array glass 110 and indicated by a dotted line.

There is an integrated circuit 130 disposed on the display panel 100 and close to the first side 111. The array glass 110 is divided into an active area and a non-active area. The active area is provided with a thin film transistor (TFT) array 140. The thin film transistor array 140 is composed of a plurality of thin film transistors 141. The non-active area is provided with a plurality of metal lines 150. As shown in FIG. 1, on the array glass 110 where the thin film transistor array 140 is disposed is the active area, and the peripheral portion of the array glass 110 where no thin film transistor array 140 disposed is the non-active area.

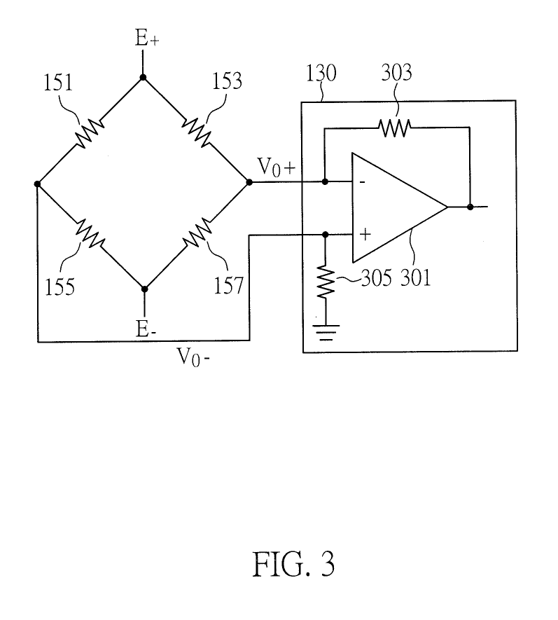

The non-active area on the array glass 110 is provided with a plurality of metal lines 150, and the plurality of metal lines 150 are connected to the integrated circuit 130. The integrated circuit 130 has an operational amplifier (see FIG. 3). The transparent protective layer 120 covers the plurality of metal lines 150, so as to form a strain gauge with the plurality of metal lines 150 and the operational amplifier of the integrated circuit 130.

The metal lines 150 include a first metal line 151, a second metal line 153, a third metal line 155, and a fourth metal line 157.

The first metal line 151 is deployed by starting from a first pin 131 of the integrated circuit 130, passing the non-active area, extending along the second side 113 to the third side 115, repeatedly bending, passing the non-active area again, extending along the second side 113 to the first side 111, and finally connecting to a second pin 132 of the integrated circuit 130.

The second metal line 153 is deployed by starting from a third pin 133 of the integrated circuit 130, passing the non-active area, extending along the fourth side 117 to the third side 115, repeatedly bending, passing the non-active area again, extending along the fourth side 117 to the first side 111, and finally connecting to a fourth pin 134 of the integrated circuit 130.

The third metal line 155 is deployed by starting from a fifth pin 135 of the integrated circuit 130, passing the non-active area, extending along the second side 113 to the non-active area between the TFT array 140 and the integrated circuit 130, repeatedly bending, passing the non-active area again, extending along the second side 113 to the first side 111, and finally connecting to a sixth pin 136 of the integrated circuit 130.

The fourth metal line 157 is deployed by starting from a seventh pin 137 of the integrated circuit 130, passing the non-active area, extending along the fourth side 117 to the non-active area between the TFT array 140 and the integrated circuit 130, repeatedly bending, passing the non-active area again, extending along the fourth side 117 to the first side 111, and finally connecting to an eighth pin 138 of the integrated circuit 130.

As shown in FIG. 1, the first metal line 151 and the second metal line 153 at the third side 115 are parallel to the third side 115 and repeatedly bent. The third metal line 155 and the fourth metal line 157 at the non-active area between the TFT array 140 and the integrated circuit 130 are parallel to the first side 111 and repeatedly bent. In this embodiment, the portion of first metal line 151 and second metal line 153 separately constitutes a U shape and its openings face each other at the third side 115. The third metal line 155 and the fourth metal line 157 have the similar design as shown in FIG. 1.

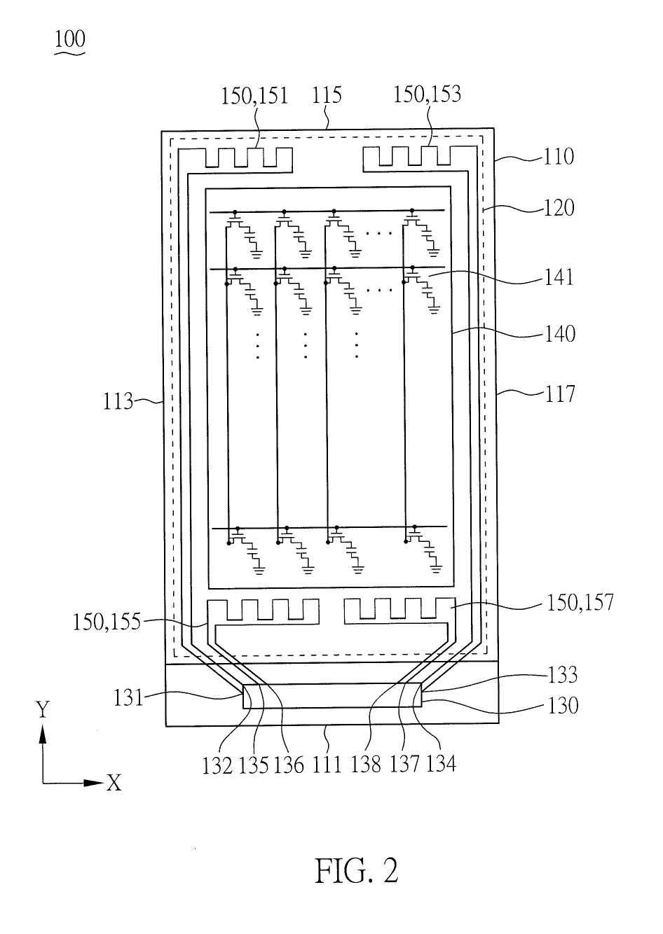

FIG. 2 is a schematic diagram of a display panel 100 with an in-cell force sensor according to another embodiment of the invention, which is similar to the embodiment of FIG. 1 except for the third side 115, where the first metal line 151 and the second metal line 153 are perpendicular to the third side 115 and repeatedly bent. The third metal line 155 and the fourth metal line 157 at the non-active area between the TFT array 140 and the integrated circuit 130 are parallel to the first side 111 and repeatedly bent. In this embodiment, the portion of first metal line 151 and second metal line 153 separately constitutes a comb shape and its openings face opposite to the active area. The third metal line 155 and the fourth metal line 157 have the similar design as shown in FIG. 2.

When there is an external force applied to the transparent protective layer on the display panel 100 with an in-cell force sensor, the resistance values of the first metal line 151, the second metal line 153, the third metal line 155, and the fourth metal line 157 are changed and, based on the changes, a magnitude of the strain corresponding to the external force can be calculated.

FIG. 3 is a schematic diagram illustrating an operation of the display panel 100 with an in-cell force sensor according to the invention. As shown in FIG. 3, the first metal line 151, the second metal line 153, the third metal line 155, and the fourth metal line 157 are connected to the integrated circuit 130 to thereby form a full-bridge load cell (Wheatstone bridge).

The first metal line 151, the second metal line 153, the third metal line 155, and the fourth metal line 157 are provided to serve as a strain gage, which is equivalent to a resistor in function. In addition, the first metal line 151, the second metal line 153, the third metal line 155, and the fourth metal line 157 are connected with an operational amplifier 301, a first resistor 303, and a second resistor 305 in the integrated circuit 130 to thus form a full-bridge load cell (Wheatstone bridge). An external voltage source (E+, E−) is applied to the Wheatstone bridge as shown in FIG. 3.

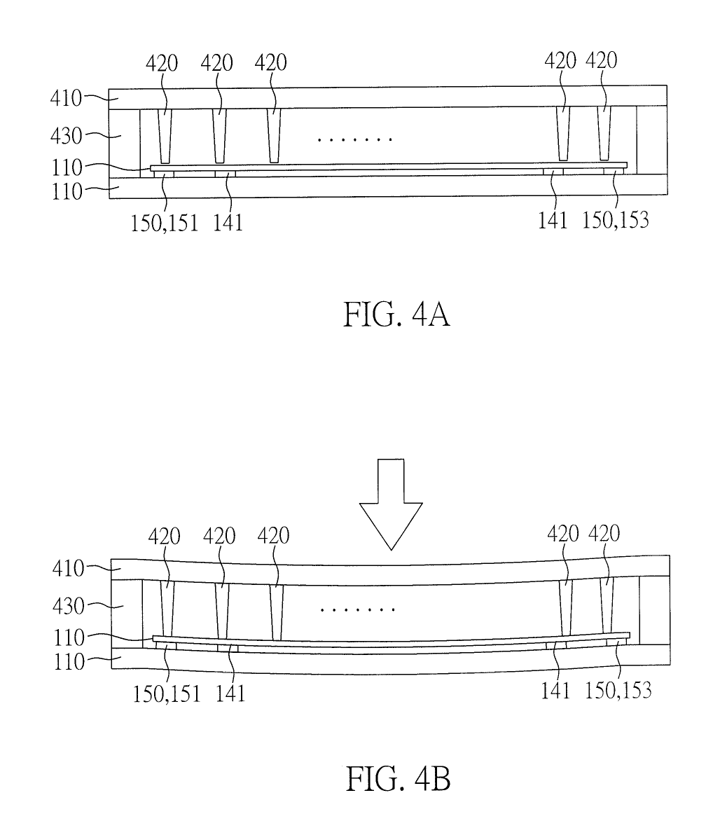

FIGS. 4A and 4B are schematic diagrams illustrating an application of the display panel 100 with an in-cell force sensor according to the invention. The plurality of metal lines 150 are disposed at the non-active area. FIG. 4A is a cross-sectional view of the display panel 100 with an in-cell force sensor and only shows the first metal line 151 and the second metal line 153. A plurality of spacers 420 are disposed between a color filter 410 and the array glass 110. The spacers 420 are very close to the transparent protective layer 120. Namely, there is a predetermined distance between the spacers 420 and the surface of the array glass 110. Furthermore, seal 430 is provided at the periphery of the color filter 410 and the array glass 110. As shown in FIG. 4B, when an external force is applied to the display panel 100, due to that the spacers 420 and the transparent protective layer 120 are very close, the spacers 420 at a pressed location is lowered down to come into touch with the transparent protective layer 120, so as to deliver the external force to the transparent protective layer 120 and the array glass 110, resulting in that the transparent protective layer 120 and the array glass 110 are slightly curved and deformed. Because the transparent protective layer 120 and the array glass 110 are deformed, the metal lines 150 are also deformed. Under a condition of constant volume, the metal lines 150 are provided with different resistance values due to the changed sectional areas and lengths. Namely, the resistance values of the metal lines 150 are changed due to the deformation of the metal lines 150. In the present invention, the first metal line 151, the second metal line 153, the third metal line 155 and the fourth metal line 157 of the full-bridge load cell are provided with resistance value changes, and thus the magnitude of the applied external force can be measured. Namely, the external force at the pressed location can be delivered to the array glass 110 through the spacers 420, so as to deform the array glass 110 and allow the full-bridge load cell to achieve the effect of detecting the applied force.

When an external force is applied to the color filter 410, the full-bridge load cell senses a strain generated on the array glass 110. At this moment, the resistance values of the second metal line 153 and the third metal line 155 are changed in opposition to those of the first metal line 151 and the fourth metal line 157, and the full-bridge load cell generates output voltages Vo+ and Vo−. The voltages Vo+ and Vo− are applied to the inverted input terminal and the non-inverted input terminal of the operational amplifier 301 for being processed and, after the processing, the output value of the operational amplifier 301 is employed to generate the magnitude of the external force corresponding to the strain. Accordingly, the force applied to the display panel 100 can be detected, so as to provide the force sensing function.

The first metal line 151, the second metal line 153, the third metal line 155, and the fourth metal line 157 are disposed on the array glass 110. Thus, the first metal line 151, the second metal line 153, the third metal line 155, and the fourth metal line 157 can be formed at the same time as the TFT array 140 is formed. Namely, while designing the mask for the TFT array 140, the first metal line 151, the second metal line 153, the third metal line 155, and the fourth metal line 157 can be designed. As a result, during the manufacturing process of the TFT array 140, the manufactures of the first metal line 151, the second metal line 153, the third metal line 155, and the fourth metal line 157 are concurrently complete, and thus the manufacturing cost is not increased. For example, when manufacturing the TFT array 140, the metal lines 150 can be formed by a first metallization process and the transparent protective layer can be a gate insulating layer, or the metal line 150 can be formed by a second metallization process and the transparent protective layer can be a protective layer covering the metal line 150 formed by the second metallization process. Therefore, the invention can provide the display panel with in-cell touch sensor 100 with the force sensing function without increasing the manufacturing cost.

Although the present invention has been explained in relation to its preferred embodiment, it is to be understood that many other possible modifications and variations can be made without departing from the spirit and scope of the invention as hereinafter claimed.

What is claimed is:

1. A display panel with an in-cell force sensor comprising an array glass and a transparent protective layer disposed on the array glass, which has a first side, a second side, a third side opposite to the first side, and a fourth side opposite to the second side, an integrated circuit being disposed on the display panel and close to the first side and provided with an operational amplifier, the array glass being divided into an active area provided with a thin film transistor array and a non-active area provided with a plurality of metal lines connected to the integrated circuit, the transparent protective layer covering the plurality of metal lines, whereby the plurality of metal lines and the operational amplifier of the integrated circuit constitute a strain gauge.

2. The display panel with an in-cell force sensor as claimed in claim 1, wherein the plurality of metal lines include a first metal line, a second metal line, a third metal line, and a fourth metal line.

3. The display panel with an in-cell force sensor as claimed in claim 2, wherein the first metal line is deployed by starting from a first pin of the integrated circuit, passing the non-active area, extending along the second side to the third side, repeatedly bending, passing the non-active area again, extending along the second side to the first side, and connecting to a second pin of the integrated circuit, and the second metal line is deployed by starting from a third pin of the integrated circuit, passing the non-active area, extending along the fourth side to the third side, repeatedly bending, passing the non-active area again, extending along the fourth side to the first side, and connecting to a fourth pin of the integrated circuit.

4. The display panel with an in-cell force sensor as claimed in claim 3, wherein the third metal line is deployed by starting from a fifth pin of the integrated circuit, passing the non-active area, extending along the second side to the non-active area between the TFT array and the integrated circuit, repeatedly bending, passing the non-active area again, extending along the second side to the first side, and connecting to a sixth pin of the integrated circuit, and the fourth metal line is deployed by starting from a seventh pin of the integrated circuit, passing the non-active area, extending along the fourth side to the non-active area between the TFT array and the integrated circuit, repeatedly bending, passing the non-active area again, extending along the fourth side to the first side, and connecting to an eighth pin of the integrated circuit

5. The display panel with an in-cell force sensor as claimed in claim 4, wherein the first metal line, the second metal line, the third metal line, and the fourth metal line are connected with the operational amplifier of the integrated circuit for forming a full-bridge load cell.

6. The display panel with an in-cell force sensor as claimed in claim 5, wherein the first and the second metal lines at the third side are parallel to the third side and repeatedly bent.

7. The display panel with an in-cell force sensor as claimed in claim 6, wherein the first and the second metal lines at the third side are perpendicular to the third side and repeatedly bent.

8. The display panel with an in-cell force sensor as claimed in claim 5, wherein the third metal line and the fourth metal line at the non-active area between the TFT array and the integrated circuit are parallel to the first side and repeatedly bent.

9. The display panel with an in-cell force sensor as claimed in claim 8, wherein the third metal line and the fourth metal line at the non-active area between the TFT array and the integrated circuit are perpendicular to the first side and repeatedly bent.

10. The display panel with an in-cell force sensor as claimed in claim 5, wherein, when an external force is applied to the display panel with the in-cell force sensor, the external force is delivered to the transparent protective layer and the array glass, such that at least one of the first metal line, the second metal line, the third metal line, and the fourth metal line is deformed to generate a resistance change, so as to calculate a magnitude of a strain corresponding to the external force.
